(19) United States
(12) Patent Application Publication
(10) Pub. No.: US 2013/0339990 A1
(43) Pub. Date: Dec. 19, 2013

(54) APPARATUS, INFORMATION PROCESSING METHOD AND PROGRAM

(71) Applicant: SONY CORPORATION, Tokyo (JP)

(72) Inventors: Tsunayuki OHWA, Kanagawa (JP); Atsushi HASHIZUME, Tokyo (JP)

(73) Assignee: SONY CORPORATION, Tokyo (JP)

(21) Appl. No.: 13/871,223

(22) Filed: Apr. 26, 2013

(30) Foreign Application Priority Data
Jun. 14, 2012 (JP) 2012134695

(51) Int. Cl. H04N 21/442

(52) U.S. Cl. CPC H04N 21/442
USPC 725/14

(57) ABSTRACT

There is provided an information processing apparatus including a first information acquiring section acquiring location specification information which indicates content being viewed by a user and a location in the content specified by the user, a second information acquiring section acquiring, based on the location specification information, content-related information provided corresponding to the content for the location, and an action support information generating section generating action support information for the user by using the content-related information.

### BACKGROUND

The disclosure relates to an apparatus, an information processing method and a program.

Content such as a television program and the like provides viewers with various information. It can be said that the content provides viewers with not only information currently treated as a main topic but also any and all of other things, such as a currently playing musical piece, performers, clothes of the performers and a background, as information. Various technologies are been proposed which are not only for simply viewing the content but also for retrieving and utilizing various information pieces provided in a broadcast program, for example, after the program is broadcasted. For example, Japanese Patent Laid-Open No. 2010-166123 discloses a technology for retrieving the title of a musical piece reproduced in a recorded content and associating the retrieved title with the content as meta information.

### SUMMARY

Although the musical piece is a target in the example of Japanese Patent Laid-Open No. 2010-166123, an attempt has already been started to provide information which is related to the information provided in the content including other various information pieces. In the case of the broadcast program for example, there is provided a service for providing information on the contents of a broadcast program at every time frame. Such information is often created and provided by, for example, an enterprise other than a broadcast enterprise. Consequently, viewers can obtain and utilize various information pieces.

However, is hard to say that satisfactorily proposed are user interfaces for a user to obtain and utilize information that is relevant to content in this way. For example, when a user hopes to obtain information on the contents of a broadcast program at every time frame, the user accesses to a Web page or the like that was prepared per program, and searches for desired information from the Web page. However, when a plurality of main topics are treated in the program for example and the user's memory is not very clear, it may not be easy to search for desired information. Even if desired information is acquired, such procedures as taking a note and bookmarking the Web page may be desirable for the user to utilize the information for his/her action. Such procedures may discourage the user to obtain information, and the information that interests the user may be forgotten in vain.

Accordingly, in the present disclosure, a new and modified apparatus, system and program for information processing, which are capable of encouraging a user to obtain and utilize the information that is relevant to content, are proposed.

According to an embodiment of the present disclosure, there is provided an information processing apparatus including a first information acquiring section acquiring location specification information which indicates content being viewed by a user and a location in the content specified by the user, a second information acquiring section acquiring, based on the location specification information, content-related information provided corresponding to the content for the location, and an action support information generating section generating action support information for the user by using the content-related information.

According to an embodiment of the present disclosure, there is provided an information processing method including acquiring location specification information which indicates content being viewed by a user and a location in the content specified by the user, acquiring, based on the location specification information, content-related information provided corresponding to the content for the location, and generating action support information for the user by using the content-related information.

According to an embodiment of the present disclosure, there is provided a program for causing a computer to execute a function of acquiring location specification information which indicates content being viewed by a user and a location in the content specified by the user, a function of acquiring, based on the location specification information, content-related information provided corresponding to the content for the location, and a function of generating action support information for the user by using the content-related information.

If the information, which indicates content and a location in the content specified by the user, is acquired, it becomes possible to retrieve, based on this information, information provided on the content and to acquire content-related information. The content-related information is information often utilized for an action of the user. Accordingly, generating action support information for the user based on the content-related information enables the user to acquire desired information in a desired form without the trouble of conducting retrieval by the user himself/herself. Therefore, the user may be encouraged to obtain and utilize content-related information, as a result of which the value of the content as an information sender may be enhanced.

According to the embodiments of the present disclosure described above, it becomes possible to encourage a user to obtain and utilize the information that is relevant to content in the present disclosure.

### BRIEF DESCRIPTION OF THE DRAWINGS

FIG. 1 is a view showing an example of a user interface presented to a user who is viewing content according to one embodiment of the present disclosure;

FIG. 2 is a view showing an example of action support information presented to the user according to one embodiment of the present disclosure;

FIG. 3 is a view showing a case where content-related information is not acquired in the example shown n FIG. 2;

FIG. 4 is a view showing an example of using the action support information according to one embodiment of the present disclosure;

FIG. 5 is a view showing an example of detailed display of the action support information according to one embodiment of the present disclosure;

FIG. 6 is a view for explaining a schedule register function according to one embodiment of the present disclosure;

FIG. 7 is a view for explaining a notice function according to one embodiment of the present disclosure;

FIG. 8 is a view for explaining an information acquisition function according to one embodiment of the present disclosure;

FIG. 9 is a view for further explaining learning in the information acquisition function explained in FIG. 8;

FIG. 10 is a block diagram showing a first example of a schematic function configuration according to one embodiment of the present disclosure;

FIG. 11 is a block diagram showing a second example of the schematic function configuration according to one embodiment of the present disclosure; and

FIG. 12 is a block diagram for explaining hardware configuration of an information processing apparatus.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be given the order shown below:

1. User interface during content viewing

2. Interface for action support

3. Use of action support information

4. Information acquisition function

5. Function configuration

6. Hardware configuration

7. Supplement

### (1. User Interface During Context Viewing)

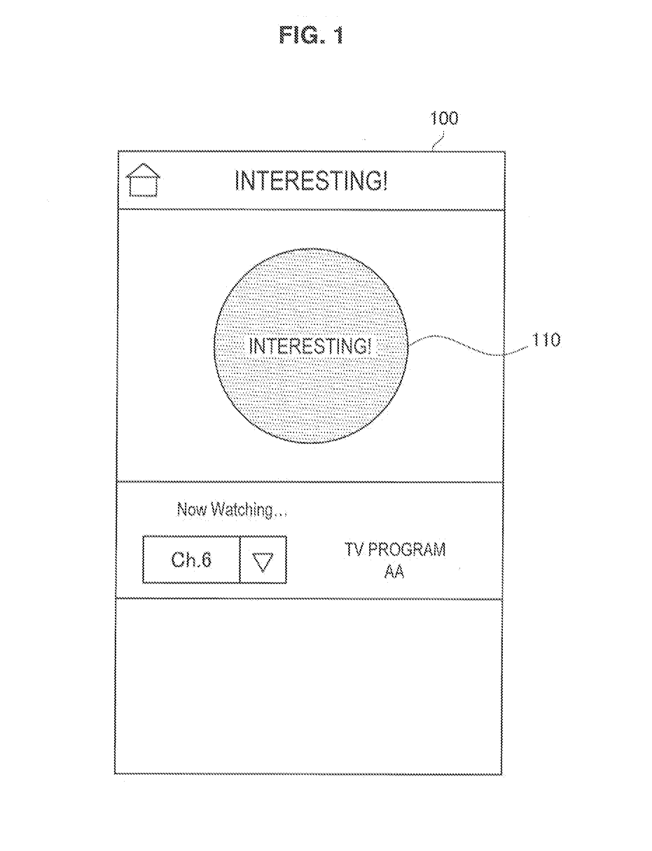

FIG. 1 is a view showing an example of a user interface presented to a user who is viewing content according to one embodiment of the present disclosure.

In embodiment of the present disclosure, a location specification screen 100 is presented to the user who is viewing content. The location specification screen 100 is a screen for acquiring a location in the content specified by the user who is viewing the content, and a button 110 is displayed in one example. In the illustrated example, the button 110 is an “Interesting!” button. When the user finds a highly interesting portion during viewing the content, the user can press the button 110 to input information that specifies the location of the portion in the content.

At the time of pressing, the user may increase the number of times of pressing the button 110 (repeated tapping) or may lengthen a duration of time to press the button 110 in proportion to the user's level of interest in the content. Consequently, information on the user's level of interest at the pertinent location may be acquired.

The location specification screen 100 may be displayed, for example, together with a control screen of a device for viewing the content. For example, the location specification screen 100 may be displayed by starting a predetermined application in such a terminal device as a mobile phone (smartphone) that functions as a remote controller of a television set. Or alternatively, the location specification screen 100 may be displayed in an area other than a content viewing area on the display in mobile phones (smartphones), various PCs (Personal Computers), and the like which themselves are used for viewing the content.

As illustrated, the location specification screen 100 may include a display which specifies the content itself. Although not illustrated, the location specification screen 100 may be, for example, integrated with a controller screen. In that case, a controller button and detailed program information, such as EPG (Electronic Program Guide), may be displayed in addition to the button 110 on the location specification screen 100.

The information indicating a location that the user specified in the content may be time stamp information when the content is, for example, a broadcast program. Or alternatively, when the content is a recorded broadcast program or a package content, location information specified by pressing the button 110 may be a seek point (information indicating elapsed time from the start of the content) set for the content.

The information indicating the location specified by the user may be, for example, an image or sound snapshot of the content. In this case, by using a library and the like where content image or sound is accumulated, content including an image or sound that matches the snapshot or a location thereof is retrieved.

For example, when an image or sound snapshot is acquired in addition to the information indicating the content, a location in the specified content where an image or sound matches the snapshot may be retrieved, and a time stamp of that location may be specified. Or alternatively, when an image or sound snapshot is acquired in addition to the information indicating the location such as a time stamp, content including an image or sound that matches the snapshot may be retrieved with the specified location so as to specify the content. Of course, by combining these two examples, both the content and the location may be retrieved from the snapshot.

In still another example, information indicating a location specified by the user may be an activity logs on a network that are relevant to various services that the user uses. The activity log may herein refer to, for example, a message log transmitted by the user or the contents of content on the network to which the user sent a reply or for which the user expressed sympathy. Such an activity log generated while the user is viewing the content is considered to be the information indicating, for example, the location of a portion in the content where the user shows interest.

For example, in the case where it is known that a user is viewing content and an activity log by the user in BBS (Bulletin Board System), SNS (Social Network Service), and the like, which are relevant to the content, is generated, then it is considered that a time stamp of the activity indicates a portion in the content where the user shows interest. Furthermore, an activity of the user being recorded in BBS, SNS, and the like, which are relevant to the content, may be treated as the information indicating that the user is viewing/has viewed the content.

### (2. Interface for Action Support)

(List Display)

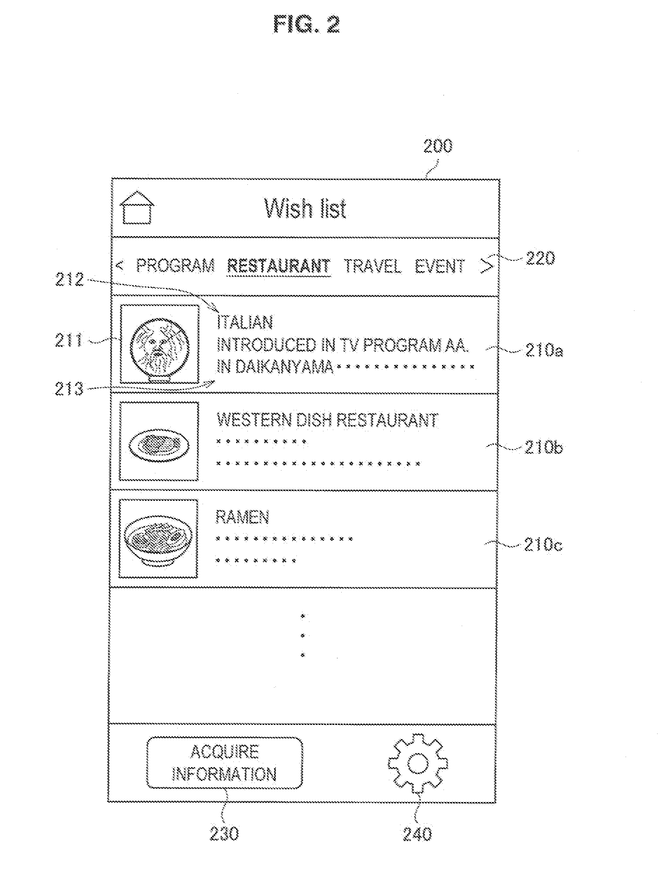

FIG. 2 is a view showing an example of action support information presented to the user according to one embodiment of the present disclosure.

In one embodiment of the present disclosure, an action support list screen 200 is presented to the user. The action support information list screen 200 is displayed, for example, on a terminal device used by the user. The terminal device may not necessarily be the same as the terminal device haying the location specification screen 100 displayed therein. In short, the device for displaying the action support information list screen 200 may be a terminal device such as mobile phones (smartphones) and various PCs used by the user. Note that in the illustrated example, a list displayed on the action support list screen 20 is referred to as “Wish List.”

The action support list screen 200 displays list information 210a, 210b, 210c . . . (hereinafter generically referred to as list information 210 in some cases) for supporting actions of the user. The list information 210 may be, for example, information on a program, information on a restaurant, information on a travel destination, or information on an event. For example, if it is the information on a program, the user can utilize the information for an action for viewing the program. If it is the information on a restaurant, the user can utilize the information for an action for eating. The list information 210 may be classified into categories according to a specified rule and be displayed on the action support list screen 200 as a category display 220 as shown in the drawing.

In the illustrated example, the list information 210a is the information acquired based on the information inputted in the above-stated location specification screen 100. In short, the list information 210a is the information (content-related information) acquired based on the information on content (that is a TV program in this case) viewed by the user and a location where the user pressed the button 110 in the content. In this example, at the time when the button 110 is pressed, the information on a restaurant taken up in the TV program is displayed as the list information 210a. Such information can be obtained by, for example, using a service provided by a broadcast enterprise (content manufacturer) or an enterprise other than the broadcast enterprise. At this time, the list information 210a may include information that indicates a corresponding content (TV program AA). Consequently, the user can recognize that the list information 210a is the information acquired as content-related information.

The list information 210 may include information other than the information acquired based on the content and the location thereof. For example, the list information 210b may be information acquired from paper media such as magazines by using a two-dimensional code and the like, and the list information 210c may be information acquired by information access via a Web browser and other applications. Thus, the action support list screen 200 may include not only content-related information but also information acquired by other various methods. In the illustrated example, the List information 210 includes a thumbnail image 211, a title 212 and a detailed text 213. These data may be acquired from, for example, API (Application Programming Interface) of a service which acquires information from each medium.

An acquire information button 230 and a set button 240 may further be displayed on the action support list screen 200. The acquire information button 230 is a button for starting a function to add further list information 210 to the action support list screen 200 based on an activity log of the user on a network. Note that this function will be described later. The set button 240 is a button for starting a function to change setting of the action support list screen 200. The setting change function with the set button 240 may change, for example, later-described notice setting.

(Case where Content-Related Information is not Acquired)

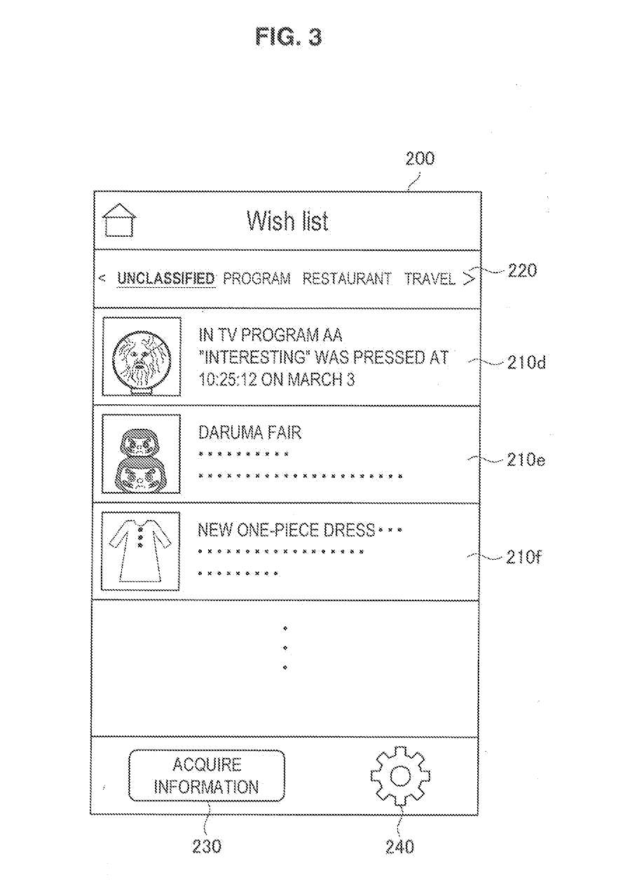

FIG. 3 is a view showing a case where content-related information is not acquired in the example shown in FIG. 2.

As described before, the content-related information of a broadcast program for example can be obtained by using a service provided by a broadcast enterprise or an enterprise other than the broadcast enterprise. Thus, since the creator of the content-related information is not limited to the broadcast enterprise, the content-related information may be created, for example, after a period of time after the broadcast program is broadcasted.

In this case, information may not yet be generated even when the user tries to acquire content-related information at the moment when the user who is viewing the content specifies a location in the content with the button 110 on the location specification screen 100 or at the moment when broadcasting is over. Furthermore, information larger in quantity (more productive) than the information available at that moment may possibly be generated thereafter.

Therefore, acquisition of content-related information may be executed after elapse of a predetermined time from the end of the broadcast program. Or alternatively, acquisition of content-related information may be executed several times during a time period from the start of broadcasting to the point where a predetermined time is elapsed from the end of broadcasting.

The illustrated example is a case where the content-related information is not acquired during broadcasting of the program and for a while after the end of the broadcasting in the example as shown in the foregoing. In this case, in the action support list screen 200, temporary content-related information including a title and a broadcasting date of content (broadcast program) is generated as list information 210d and is displayed on the action support list screen 200 in place of the content-related information. In this case, time stamp information may be displayed on the list information 210d as location information specified by the user.

In this case, since the detail of the list information 210d is unknown, it may temporarily be classified into, for example, an “unclassified” category. Then, if information (restaurant information) like the list information 210a in the example of FIG. 2 is acquired as the content-related information for example, the list information 210d is replaced with the list information 210a. Further, the List information 210a may automatically be classified into an appropriate category (a “restaurant” category in the example of FIG. 2).

### (3. Use of Action Support Information)

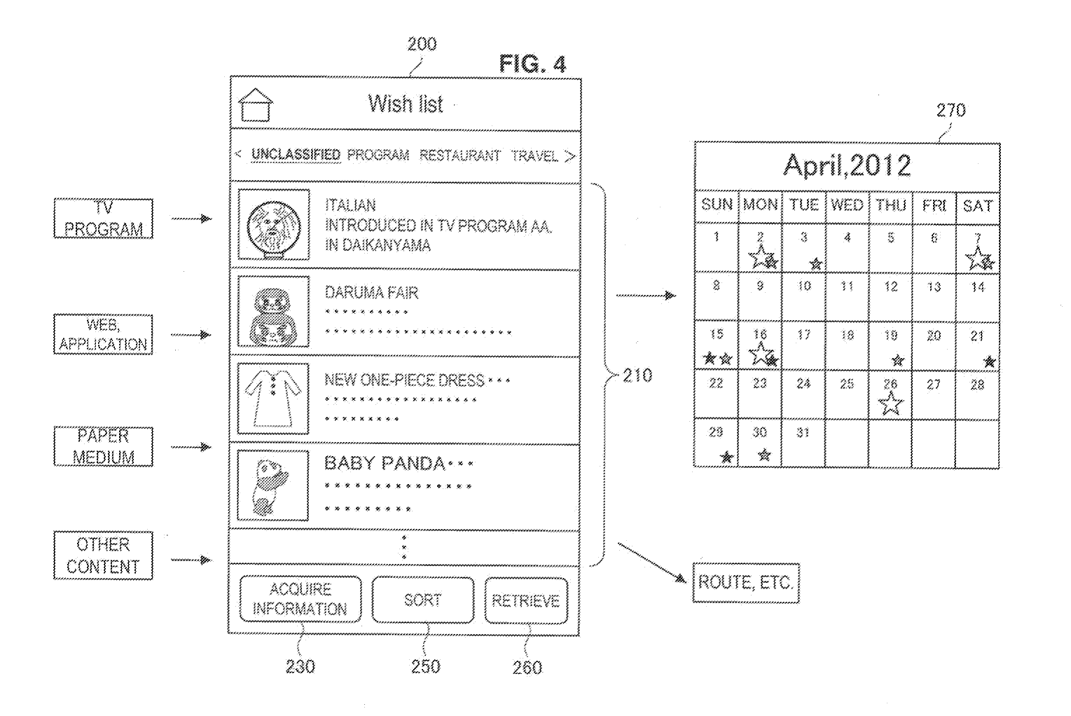

FIG. 4 is a view showing an example of using the action support information according to one embodiment of the present disclosure.

As in the above-stated example, the action support information may be acquired from the content such as a TV program. In addition, the action support information may be acquired from paper media such as magazines by using a two-dimensional code and the like, and may be acquired by access to information with a Web browser and other applications. In the illustrated example, the thus-acquired information is registered as action support information and is displayed on the action support information list screen 200.

The information to be registered as the action support information may be any information that can assist the user to determine his/her own action, such as, for example, things the user wants, foods the user wants to eat, places the user wants to go, events the user wants to participate, movies the user wants to watch, and broadcast programs the user wants to view. As illustrated, the action support information may be classified into categories according to a specified rule and be displayed. Examples of categories into which the action support information is classified may include, for example, a broadcast program, a restaurant, a travel, and an event, and these categories may be based on attributes of subjects. Furthermore, the action support information may be classified according to how the subjects, such as materials, people, articles, and topics, are treated.

In the illustrated example, the list information 210 is displayed on the action support information list screen 200 according to the classification into the above-stated categories. In order to control a display of such list information 210, a sort button 250 and a retrieve button 260 may be displayed (a user interface example different from those of FIGS. 2 and 3 shown above).

By calling a later-described detailed information screen from each list information 210 displayed on the action support information list screen 200, the user can register a schedule regarding the list information 210 in, for example, a calendar 270. Once the schedule is registered in the calendar 270, a notice as described later may be outputted when a scheduled date is close, In the case where the list information 210 is information corresponding to a broadcast program, it may be possible to request reservation of video recording of the program from a recorder and the like.

Furthermore, the user may be able to generate, based on each information 210, route information for accessing to information indicated by each list information 210. The route information may include route guidance information at the time of going to, for example, a store, a travel destination, and an event hall. These functions may be provided as collaborative functions which can be started, for example, from the action support information list screen 200.

The user can also share or express sympathy for each list information 210 through a network service such as SNS. The user may further be able to retrieve relevant information by using each list information 210 as a starting point.

(Detailed Display)

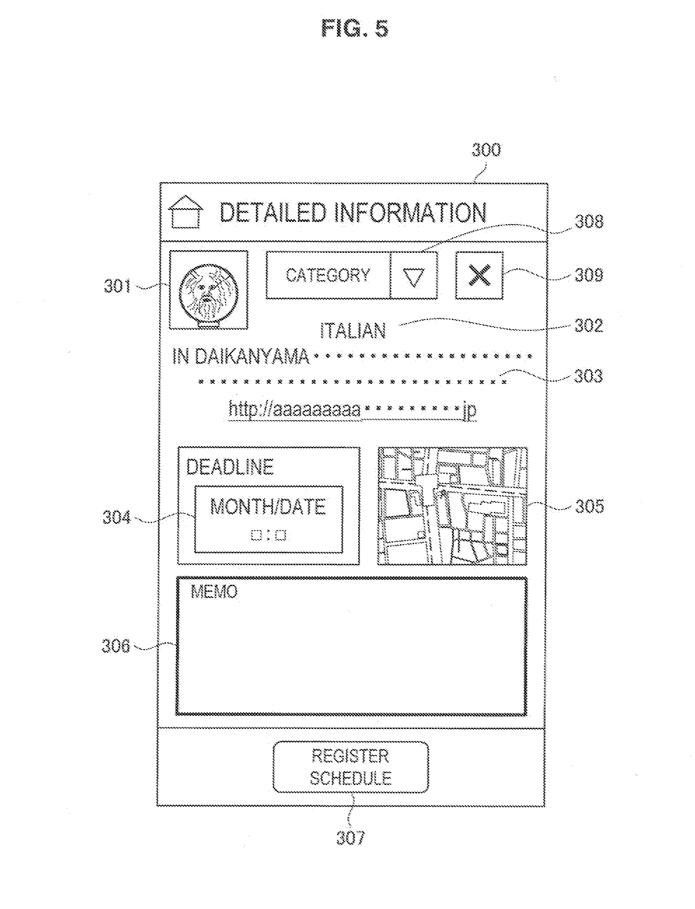

FIG. 5 is a view showing an example of detailed display of the action support information according to one embodiment of the present disclosure.

As described above, according to the present embodiment, it is possible to call from each list information 210 displayed on the action support information list screen 200 a detailed information screen 300 corresponding to pertinent list information. In the illustrated example, the detailed information screen 300 includes, for example, a thumbnail image 301, a title 302, a detailed text 303, a deadline display 304, a map display 305, a memo 306, a. register schedule button 307, a category display 308, and a delete button 309.

The thumbnail image 301 and the title 302 may be the same as, for example, the thumbnail image 211 and the title 212 which are displayed in the list information 210 on the action support information list screen 200. For example, the detailed text 303 may be longer than the detailed text 213 displayed in the list information 210 and may also include an URL (Uniform Resource Locator) and the like to a web page as shown in the drawing.

The deadline display 304 indicates a deadline that is associated with information. The deadline may be a time limit initially set for a target of the action support information, such as a last opening day in the case of an event, and a last sales day in the case of a shop. In this case, the set deadline is automatically displayed in the deadline display 304. Or alternatively, the user may selects the deadline display 304 and calls a deadline input screen, so as to change the deadline or set a new one according to his/her own schedule.

The map display 305 shows a location associated with information. The location may be a location corresponding to a target of the action support information, such as, for example, an event site in the case of an event and a shop location in the case of a shop. The information for displaying the map display 305 may be acquired, for example, at the time of acquiring content-related information, or a map information acquisition process may be executed by selection of the map display 305 after the detailed information screen 300 is displayed.

The memo 306 is an input column for inputting a memo in association with information. For example, the inputted memo may be reflected in the display contents of the list information 210 on the action support information list screen 200.

The register schedule button 307 is a button for calling a later-described schedule register function.

The category display 308 displays categories into which information is classified. The category display 308 may be a pulldown selection display as illustrated. The categories for information classification may be changed when the user changes the selection display.

The delete button 309 is a button for deleting information. When the user selects the delete button 309, a confirmation dialog is displayed and then pertinent information is deleted. Once deletion is executed, the information is deleted from the action support information list screen 200.

(Schedule Register Function)

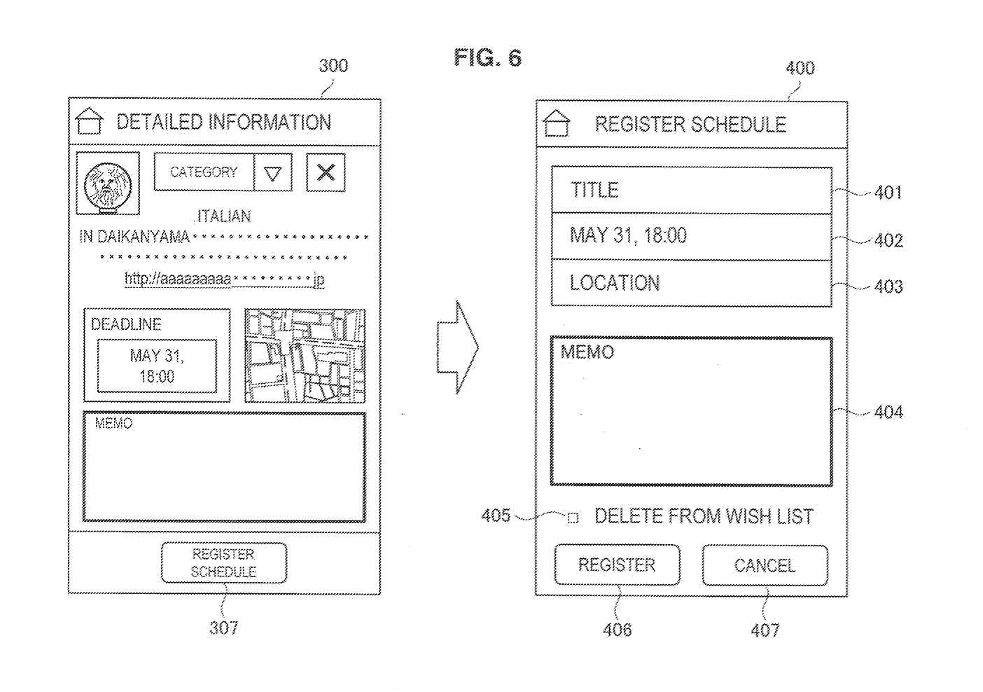

FIG. 6 is a view for explaining the schedule register function according to one embodiment of the present disclosure. As described above, using the register schedule button 307 on the detailed information screen 300 makes it possible to call the function to register schedule regarding the corresponding action support information. A schedule register screen 400 is displayed in the schedule register function. In the illustrated example, the schedule register screen 400 includes a title 401, a scheduled date 402, location information 403, a memo 404, a list delete display 405, a register button 406, and a cancel button 407.

The title 401 is a title of a schedule. Accordingly, the title 401 may be different from the title displayed on the action support information list screen 200 or the detailed information screen 300. Therefore, the title 401 may be displayed as an editable input column. A title same as the title 302 displayed on the detailed information screen 300 that is a call origin may initially be set in the title 401.

The scheduled date 402 is a display for setting time and date of schedule information. The scheduled date 402 may be, for example, a standard date/time input display provided by an OS (Operating System).

The location information 403 is a display for setting the location of schedule information. The location information 403 may be, for example, location information written in texts or may be a link to map information and the like.

The memo 404 is an input column for inputting a memo in association with schedule information. In addition to the memo inputted by the user, the detailed text 303 displayed on the detailed information screen 300 or the contents of the memo 306 may automatically be added to the memo 404. Furthermore, these information pieces may be set as default in the case where the user does not input a memo.

The list delete display 405 is a display for selecting, after registration of schedule information, whether to delete the information, which serves as the basis of the schedule information, from the action support information list screen 200. For example, when the purpose of action support information is considered to be accomplished by schedule registration, the action support information may be deleted from the list upon registration of the schedule. In the illustrated example, a check box unchecked in the default display (OFF) is displayed. Once the check box is checked (ON), action support information is deleted from the list.

Register and cancel of schedule information are executed with the register button 406 and the cancel button 407. When the register button 406 is selected, a schedule with the detail inputted on the schedule register screen 400 is registered. A registration destination may be, for example, a calendar provided by an application. The calendar may display not only the schedule registered from the schedule register screen 400 but also various schedules directly registered by the user.

(Notice Function)

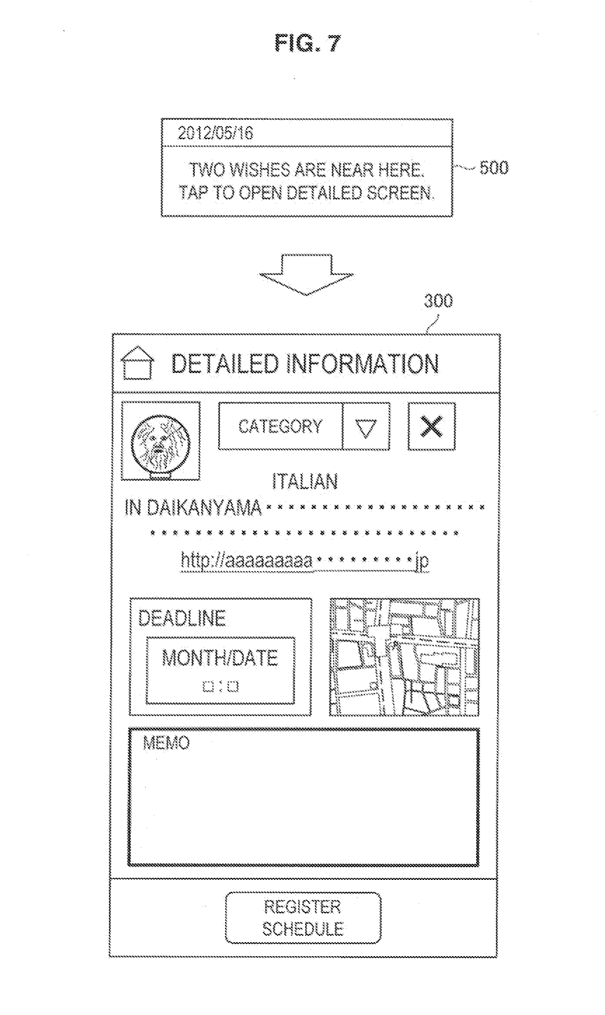

FIG. 7 is a view for explaining a notice function according to one embodiment of the present disclosure. As described above, according to the present embodiment, it is possible to set so that a notice is outputted based on action support information.

A notice display 500 may be provided, for example, by using a notice function provided by the OS. A notice function is a function to automatically display newly arrived information or the like in a specified area (referred to as a notice area or the like) of a display section. For example, an application which provides the above action support information may display the notice display 500 by using API of the OS. When the notice display 500 is selected, the above described detailed information screen 300 is opened.

Here, some examples of a condition for outputting a notice with the notice display 500 may be considered. A first example is a notice using the user's location information. As described above, the action support information is associated with a location attribute such as, for example, an event site and a shop location. Accordingly, a notice may be outputted to the user when the user's location information is close to a target location. In this case, it is possible to set parameters such as a threshold of distance between the target location and the user's location information and frequency of checking the user's location information.

A second example is a notice using time information. As described before, the action support information is associated with a deadline attribute such as, for example, an opening period of an event and a sales period of a shop. Accordingly, when the deadline is close, a notice may be outputted to the user. In this case, when the deadline is set by date for example, presence of the information that expires next day may be checked at predetermined time every day, and if the information is present, then a notice may be outputted. In this case, it is possible to set, for example, what time the deadline is checked and how long before the deadline a notice is outputted (for example, the next day, in two days, in three days, in one week, in one month, etc.).

As a result of outputting the notice according to the conditions as in the above-stated example, a plurality of action support information notices may simultaneously be outputted as in the illustrated example (shown with expression “Two wishes are near here”). If the user selects the notice display 500 in this state, the information positioned nearer to the user may be determined based on the location information and be displayed on the detailed information screen 300 for example.

### (4. Information Acquisition Function)

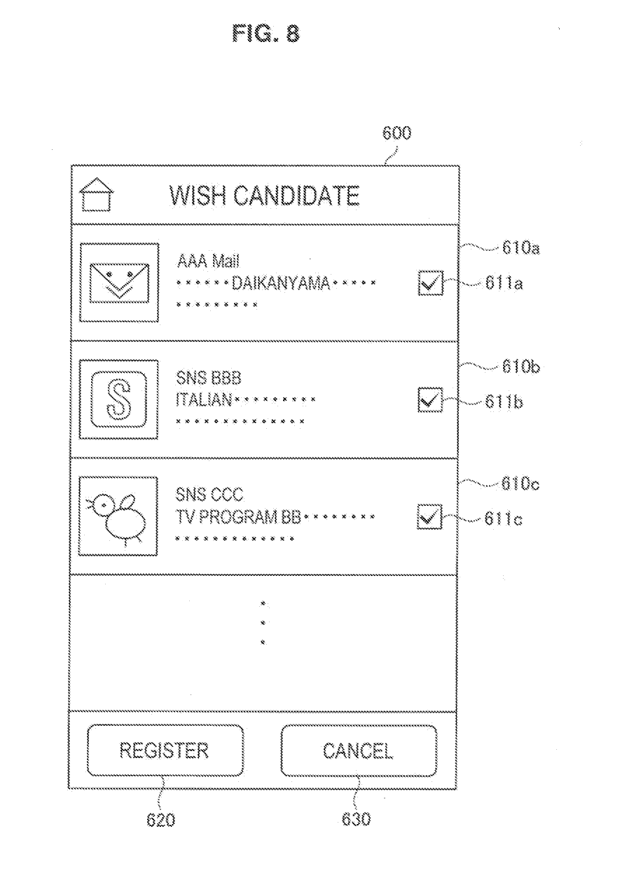

FIG. 8 is a view for explaining an information acquisition function according to one embodiment of the present disclosure. On the action support information list screen 200, it is possible to call the information. acquisition function with the acquire information button 230 as described above. In the information acquisition function, new action support information candidates are automatically generated based on a character string extracted from an activity log on a network that are relevant to various services that the user uses.

In the illustrated example, there is displayed a candidate display screen 600 that displays automatically generated action support information candidates. The candidate display screen 600 displays candidate information 610a, 610b, 610c, . . . (hereinafter generically referred to as candidate information 610 in some cases) extracted based on the activity log of each service. Like the list information 210 displayed on the above-described action support list screen 200, the candidate information 610 is, for example, information on a program, information on a restaurant, information on a travel destination, and information on an event. The candidate information 610 may be retrieved by, for example, using the information extracted from the activity log on the network that is relevant to each service.

The activity log includes, for example, a message log transmitted or received by the user. For example, such a message log may be text information in a reception mail or transmission mail acquired by using API of a mail service. Or alternatively, the message log may also be the contents of a message posted by the user to a service such as SNS and the like, It is considered that such a message log includes the details of the user inviting friends to a restaurant or an event and the details of the user discussing about one's interest. Accordingly, it is possible, for example, to estimate a user's interest based on the character string extracted from the message log.

Furthermore, the activity log includes, for example, the contents of content on the network in which the user took action. For example, in a service such as SNS, it is possible to post a message to other users, send a reply, to register a favorite, to share with other users, or to express sympathy. It is considered that the content subjected to such actions of the user reflects an interest of the user. Accordingly, it is possible, for example, to estimate an interest of the user based on the character string extracted from such content.

As illustrated, the candidate information 610 may display the service that serves as a basis for information extraction. The candidate information 610a is candidate information extracted from a mail service, while the candidate information 610b and 610c are candidate information extracted from SNS, respectively. It is to be noted that the candidate information 610 extracted from each service may not be limited to one, but two or more candidate information pieces may be extracted from one service.

The user selects candidate information 610 that is to be registered as action support information by using, for example, a check box 611 displayed in each candidate information 610. Register of the candidate information 610 is executed by using a register button 620. When the register button 620 is selected without the check box 611 of any candidate information 610 being selected, or when a cancel button 630 is selected, no candidate information 610 is registered as action support information. It is to be noted that when no candidate information 610 exists as a result of an extraction process, a notice thereof is displayed.

Although the candidate information 610 is registered as action support information in the illustrated example, it may be possible to directly register a

schedule in the candidate information 610 in another embodiment providing the above-stated schedule register function. Or alternatively, it may be possible to select whether the candidate information 610 is registered as a schedule, registered as action support information, or registered as both the schedule and the action support information.

(Learning in Information Acquisition Function)

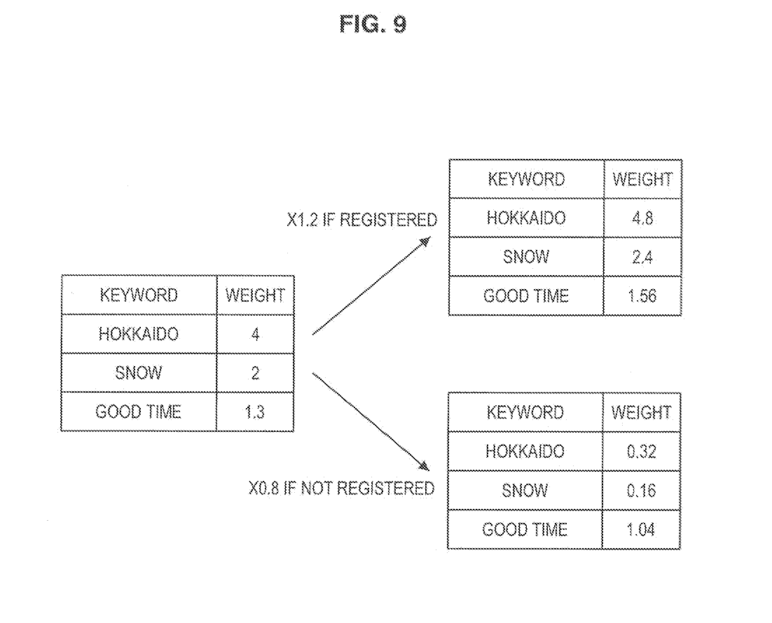

FIG. 9 is a view for further explaining learning in the information acquisition function explained in FIG. 8.

In the information acquisition function according to the present embodiment, candidates of action support information are generated based on a character string extracted from an activity log. As described above, the character string extracted from the activity log is considered, for example, to reflect an interest of the user. However, the extracted character string may include words having little relationship with the interest of the user. Accordingly, in the present embodiment, candidates of the action support information closer to the interest of the user are generated by accumulating learned data about keywords included in the character string. Hereinafter, one example of keyword learning in the present embodiment will be introduced.

Assume that a character string as shown below is present in the activity log for example. “I've been to Hokkaido. Snow was great, had a good time! ” For example, keywords “Hokkaido”, “snow”, and “good time” may be extracted from this character string. A score is set to each keyword in order to use the keywords for acquisition of action support information.

For example, in the case of the keyword which already exists in the learned data, a weighing value associated with this keyword in the learned data is multiplied by the score. Furthermore, as for the keywords of a type that are estimated to have high possibility of being related to the action support information, such as “keywords relating to places”, their score may be set higher. On the contrary, as for the keywords of a type that are estimated to have low possibility of being related to the action support information, their score may be set lower.

FIG. 9 shows an example in which the score is set for each keyword in accordance with such setting. In the example of FIG. 9, a weight of 4, 2, and 1.3 are set to keywords “Hokkaido”, “snow”, and “good time”, respectively. Therefore, the score of the character string is as follows:

1×4+1×2+1×1.3=7.3

Here, the score of the character string is compared with a specified threshold, and if the score is more than a threshold, the character string is used for retrieval of action support information candidates. For example, if the score threshold is set to 5, then the above character string with a score of 7.3 is used for retrieval of the action support information candidates. The information acquired as a result of the retrieval is presented to the user in the form of, for example, the candidate information 610 in the above-stated example, and out of the candidate information pieces, one selected by the user is registered as the action support information.

Here, the weighing value set for each keyword may be updated corresponding to the result of selection of the candidate information by the user. In short, the result of selection of the candidate information by the user may be accumulated as learned data for information acquisition. In the illustrated example, when the user registers the candidate information, which was retrieved by using the character string, as action support information, the weighing value of the keyword in the character string is updated to be 1.2 times the previous value (i.e., the value is increased). When the user does not register the candidate information, which was retrieved by using the character string, as action support information, then the weighing value of the keyword in the character string is updated to be 0.8 time the previous value (i.e., the value is decreased).

Thus, in the present embodiment, the weighing values of the keywords are updated based on the result of selection of candidate information in the case where keywords are included in various character strings and are used as retrieval targets. More specifically, a keyword that is used in retrieval of candidate information and registered as action support, information gains a larger weighing value, so that the character string including the keyword tends to be used more for retrieval. Furthermore, a keyword that is used in retrieval of candidate information but is not registered as action support information gains a smaller weighing value, so that the character string including the keyword tends to be used less for retrieval. As a result, it becomes possible to retrieve candidate information by using, for example, the character string which includes the keywords that are closer to the interest of the user.

Although candidate information is retrieved by using a character string in the above-stated example, candidate information may be retrieved by using a keyword. Furthermore, the content on the network used for retrieval may not be limited to text content, but may be, for example, an image. In that case, for example, a subject projected in an image may be specified by image processing and text retrieval is thereby performed, or an image itself may be used for image retrieval.

(Learning Based on Content-Related Information)

Content-related information may be used for learning in the information acquisition function described above. For example, characteristics of content-related information may be used for this learning. As described above, the content-related information is the information acquired based on information on content and on a location in the content specified by the user. By using the content-related information, action support information may be generated.

Accordingly, in the present embodiment, characteristics of the content-related information are accumulated as learned data. For example, when the acquired content-related information is information on a program, the content-related information may include information on a program title, a genre, performers and a summary of the contents. For example, when the content-related information is information on a restaurant, the content-related information may include information on a restaurant name, a category, a typical menu and a location. Keywords are extracted from such information for example, and are accumulated as learned data. Categories of the content-related information, such as a program, a restaurant, and an event, may also serve as characteristics of the content-related information.

The information acquired as the content-related information is the information provided, for example, at a portion where the user showed interest in the content. Therefore, it is desirable for the information, which includes characteristics of the content-related information, to be more easily retrieved at the time of information acquisition. Therefore, for example, keyword information included in the content-related information may be accumulated as learned data, and weighing values of the keywords for use in the above-stated information acquisition function may be set larger. Furthermore, for example, categories of the content-related information may be accumulated as learned data, and among the information retrieved in the information acquisition function, information in the category that is frequently extracted as content-related information may preferentially be presented as candidate information.

### (5. Function Configuration)

Now, one embodiment of the present disclosure explained in the foregoing will be explained as a function configuration, In the following description, a first example and a second example of the function configuration will be explained.

### First Example

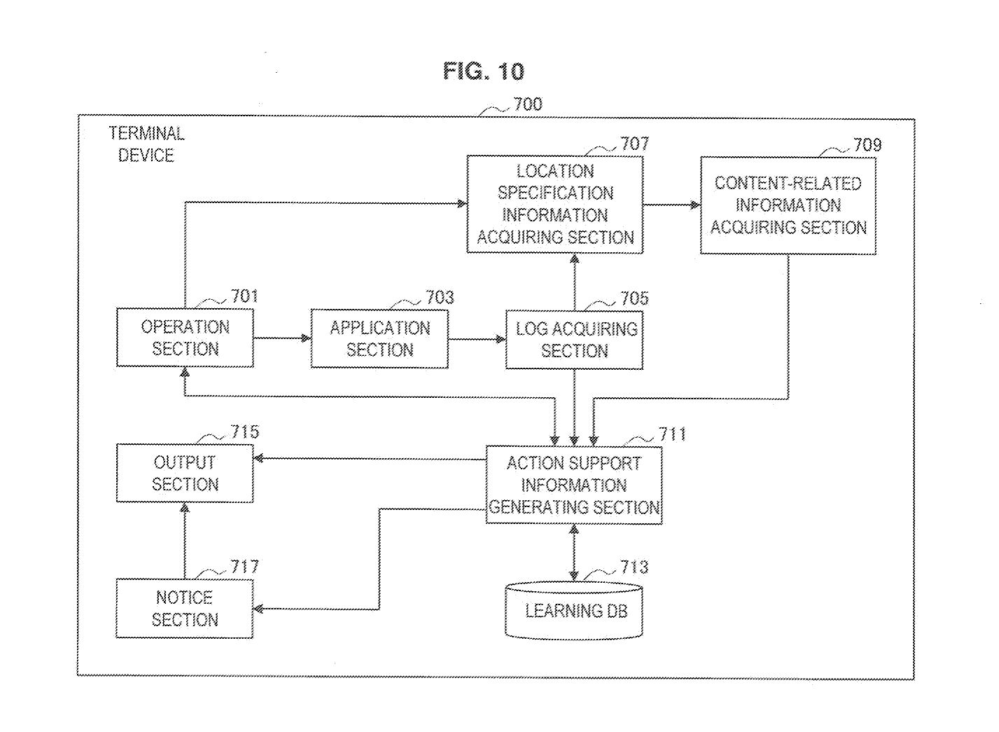

FIG. 10 is a block diagram showing the first example of a schematic function configuration according to one embodiment of the present disclosure. With reference to FIG. 10, each function configuration is included in a terminal device 700. The terminal device 700 may include an operation section 701, an application section 703, a log acquiring section 705, a location specification information acquiring section 707, a content-related information acquiring section 709, an action support information generating section 711, a learning DB 713, an output section 715, and a notice section 717.

The terminal device 700 may be, for example, a mobile phone (smartphone included) or various PCs. The terminal device 700 may be implemented by using, for example, the hardware configuration of a later-described information processing apparatus. It is to be noted that unless otherwise specified, each function configuration may be implemented as software by using a CPU (Central Processing Unit).

The operation section 701 is implemented by various kinds of put devices, such as, for example, a touch panel, a keyboard, and a mouse. The operation section 701 acquires various operations of the user with respect to the terminal device 700. For example, the operation section 701 acquires operation of the user that is to specify a location in the content. This operation may be, for example, pressing of the button 110 on the location specification screen 100. It should naturally be understood that the operation is not limited to the pressing of the button but may be various kinds of operations.

In this case, the operation section 701 may acquire information indicating the presence of user's operation for specifying the location, as well as information indicating an operation amount in the case where the operation is present, and may provide the information to the location specification information acquiring section 707. In the case of the button 110 for example, the operation amount may be the number of times of pressing the button 110, or duration of time to continuously press the button 110. The operation amount information may be provided to the action support information generating section 711 via the location specification information acquiring section 707 and the content-related information acquiring section 709, and may be used as information indicating a user's level of interest. The information indicating the user's level of interest obtained herein may be reflected in the learned data which is accumulated by the action support information generating section 711. To put it more concretely, as for the information which draws a higher interest of the user, the characteristics of the information in the learned data may have a larger weight.

The operation section 701 also acquires various kinds of operations of the user with respect to the action support list screen 200, the detailed information screen 300, the schedule register screen 400, the notice display 500, the candidate display screen 600, and the like, in addition to the operation with respect to the location specification screen 100.

The application section 703 may be application software which provides various kinds of services that the user uses in the terminal device 700. For example, the application section 703 provides a mail service and a service such as SNS.

The log acquiring section 705 acquires activity logs generated when the user uses various kinds of services via, the application section 703. For example, the log acquiring section 705 acquires a message log and information on a target of a user's action by using API provided by the application section 703. Such an activity log is provided, for example, to the action support information generating section 711 and is used for retrieval of candidate information in the information acquisition function. The activity log may also be provided to the location specification information acquiring section 707 and may be used as information indicating a location that the user specified in the content.

The location specification information acquiring section 707 is a first information acquiring section acquiring location specification information which indicates content currently viewed by the user and a location in the content specified by the user. As shown in the above-described example, the location specification information acquiring section 707 can acquire location specification information based on various information pieces. For example, the location specification information acquiring section 707 may acquire direct operation of the user to specify the location, like the operation of pressing the button 110 on the location specification screen 100, via the operation section 701. It is to be noted that the location specification information acquiring section 707 may collectively acquire the information indicating content and the information indicating a location, and may acquire them separately.

The location specification information acquiring section 707 may also acquire an image or sound snapshot of the content, which is acquired in response to operation of the user with respect to the operation section 701, as the information indicating either the content or the location, or indicating both the content and the location. The location specification information acquiring section 707 may acquire an activity log of the user on the network, which is acquired by the log acquiring section 705, as the information indicating either the content or the location, or indicating both the content and the location. Herein, in the location specification information, information indicating a location in the content may be, for example, a time stamp or a seek point. The location specification information acquiring section 707 may acquire such information itself, or may convert the acquired information (including a snapshot for example) into such information.

The content-related information acquiring section 709 is a second information acquiring section which acquires, based on the location specification information provided from the location specification information acquiring section 707, content-related information provided corresponding to the content at every location. The phrase “provided corresponding to the content at every location” signifies that the information to be provided is determined by specifying the location as well as the content. For example, when the content includes several segments, and information treated in each segment is provided as content-related information, the content-related information pieces provided in respective segments may be different from each other. For example, when information on a music pieces playing in the content, performers, clothes of the performers and a background is provided as content-related information, the provided content-related information may change moment by moment corresponding to the location in the content. The content-related information acquiring section 709 acquires such information by specifying the location in the content by using, for example, a time stamp or a seek point.

It is to be noted that the content-related information acquiring section 709 acquires content-related information by using, for example, a service provided on a network. The service may be provided by a content producer and may be provided by the third party other than the content producer. As in the above-stated example, while the user is viewing or after the user viewed the content, the content-related information acquiring section 709 can acquire content-related information from the service via the network in a separate manner. The content-related information acquiring section 709 may also extract content-related information from the information acquired with the content.

The action support information generating section 711 generates action support information for the user by using the content-related information provided from the content-related information acquiring section 709. As described above, the action support information is not limited to content-related information, but also includes information acquired from paper media such as magazines and by a Web browser and other applications. The action support information may be any information that can assist the user to determine his/her own action, such as, for example, things the user wants, foods the user wants to eat, places the user wants to go, events the user wants to participate, movies the user wants to watch, and broadcast programs the user wants to view. In order to generate such action support information, the action support information generating section 711 may use the information provided as content-related information as it is, or may use the provided information for further retrieval of information. The action support information generating section 711 not only provides action support information as, for example, the above-stated action support list screen 200 to the user, but also provides to the user various functions such as a schedule register function and a notice function that are relevant to the action support information in the form of, for example, the detailed information screen 300, the schedule register screen 400, and the like via the output section 715.

The action support information generating section 711 also provides the aforementioned information acquisition function in response to, for example, operation of the user with respect to the operation section 701. The action support information generating section 711 extracts a character string from an activity log of the user on a network provided from the log acquiring section 705, and acquires information relevant to the character string as log related information. For example, the action support information generating section 711 retrieves information with use of the extracted character string, and acquires the result of retrieval as log related information. The acquired information is presented to the user as candidate information. Further, the information selected by the user from candidate information is registered as action support information. Here, the action support information generating section 711 learns, for retrieval of candidate information, characteristics of the information registered in the action support information out of the content-related information and candidate information. As a result, the information closer to the uses interest may be extracted as candidate information.

The learning DB 713 is a data base for the action support information generating section 711 to accumulate learned data. The information accumulated in the learning DB 713 may be, for example, characteristics of the information acquired by the content-related information acquiring section 709 as content-related information and of the information which is registered as action support information selected by the user out of candidate information extracted by the action support information generating section 711. For example, when the acquired content-related information is information on a program, the content-related information may include information on a program title, a genre, performers and a summary of the contents. Moreover, when the content-related information is information on a restaurant for example, the content-related information may include information on a restaurant name, a category, a typical menu and a location. Keywords are extracted from such information for example, and are accumulated as learned data. Categories of the content-related information, such as a program, a restaurant, and an event, may also serve as characteristics of the content-related information.

The output section 715 is implemented by, for example, various kinds of output devices, such as a display and a speaker for example. The output section 715 presents to the user the action support information and the candidate information generated by the action support information generating section 711. The output section 715 displays, for example, the action support list screen 200, the detailed information screen 300, the schedule register screen 400, the candidate display screen 600, and the like. The output section 715 also displays the notice display 500 in response to notice determination in the notice section 717. It is to be noted that output of the information by the output section 715 is not necessarily limited to visual output through a display but may include, for example, audio output through a speaker.

The notice section 717 acquires the action support information from the action support information generating section 711, and controls notice output based on the acquired information. For example, the notice section 717 outputs a notice display from the output section 715 by using API of the OS. As described in the foregoing, the notice section 717 determines the presence of notice output based on user's location information or time information.

### Second Example

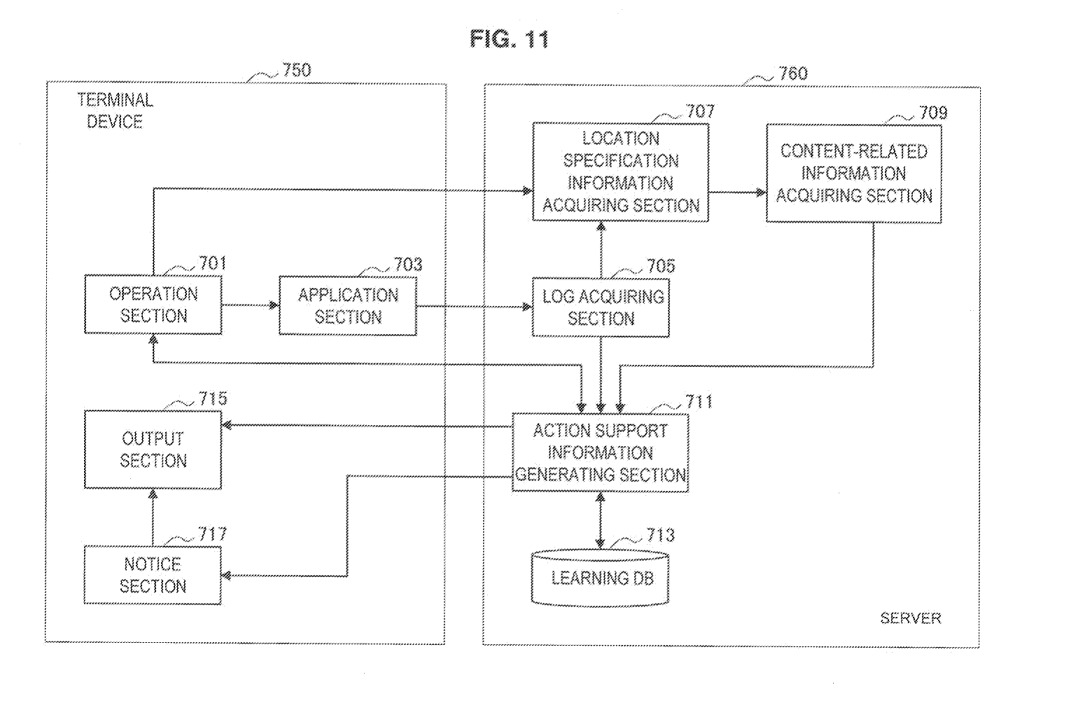

FIG. 11 is a block diagram showing the second example of a schematic function configuration according to one embodiment of the present disclosure. With reference to FIG. 11, the same function configuration as the first example in FIG. 10 is implemented with a terminal device 750 and a server 760. In the illustrated example, the terminal device 750 includes an operation section 701, an application section 703, an output section 715, and a notice section 717. On the other hands, the server 760 includes a log acquiring section 705, a location specification information acquiring section 707, a content-related information acquiring section 709, an action support information generating section 711, and a learning DB 713.

The terminal device 750 may be, for example, a mobile phone (a smartphone included) or various PCs. The terminal device 750 may be implemented by using, for example, the hardware configuration of a later-described information processing apparatus. The terminal device 750 and the server 760 are connected via various kinds of wired or wireless networks. The server 760 may be implemented by one or a plurality of server devices on a network. For example, functions of respective servers may collectively be implemented by one server device, or the functions of respective servers may be distributed and implemented by a larger number of server devices. The respective server devices may each be implemented by using, for example, the hardware configuration of a later-described information processing apparatus. When there are a plurality of server devices, each server device is connected through various kinds of wired and wireless networks.

Since the details of each function configuration are similar to that in the above-stated first example, detailed explanation thereof will be omitted. Which function configuration is implemented by which device, the terminal device 750 or the server 760, is not limited to the illustrated example but may be set in a given way.

### (6. Hardware Configuration)

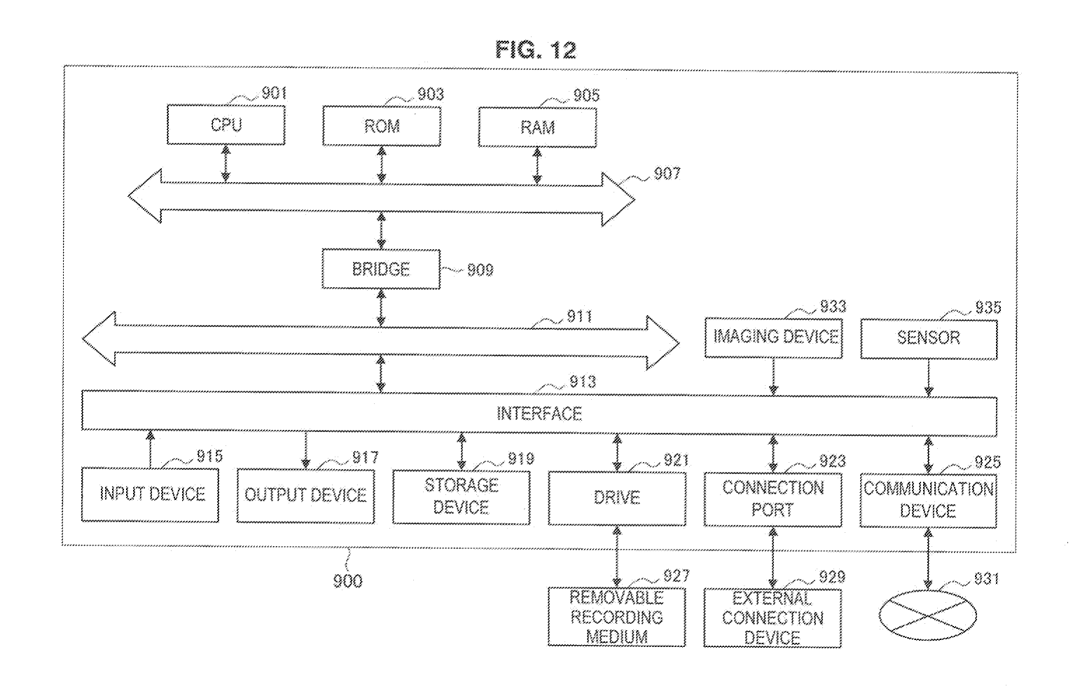

Now, with reference to FIG. 12, the hardware configuration of an information processing apparatus according to the embodiment of the present disclosure will be explained. FIG. 12 is a block diagram for explaining hardware configuration of the information processing apparatus. The illustrated information processing apparatus 900 may implement, for example, the terminal devices 700, 750, and the server 760 in the above-stated embodiment.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. Further, the input device may include an imaging device, various type of sensor, or the like as necessary. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 may be a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as LCD (Liquid Crystal Display), PDP (Plasma Display Panel), and organic EL (Electro-Luminescence) displays, an audio output device such as speaker and headphone, and a peripheral device such as printer. The output device 917 may output the results obtained from the process of the information processing apparatus 900 in a form of a video such as text or image, and an audio such as voice or sound.

The storage device 919 is a device for data storage which is configured as an example of a storage unit of the information processing apparatus 900. The storage device 919 includes, for example, a magnetic storage device such as HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USE (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The imaging device 933 is a device picking up an image of real space to generate a picked-up image pick by using, for example, various kinds of components including imaging elements, such as a CCD (Charge Coupled Device) and a CMOS (Complementary Metal Oxide Semiconductor), and lenses for controlling formation of an object image in the imaging element. The imaging device 933 may pick up a static image and may pick up a dynamic image.

For example, the sensor 935 may be various kinds of sensors, such as an acceleration sensor, a gyro sensor, a magnetic field sensor, an optical sensor, and a sound sensor. The sensor 935 acquires information on the state of the information processing apparatus 900 itself, such as the posture of a casing of the information processing apparatus 900, and information on the peripheral environment of the information processing apparatus 900, such as brightness and noise in the periphery of the information processing apparatus 900. The sensor 935 may also include a GPS (Global Positioning System) sensor which receives a GPS signal and measures a latitude, a longitude, and an altitude of the apparatus.

In the forgoing, one example of the hardware configuration of the information processing apparatus 900 has been shown. Each of the above-stated component members may be configured with use of general-purpose components, or may be configured by hardware having a specialized function of each component member. Such configuration may suitably be modified corresponding to the skill level at the time of implementation.

### (7. Supplement)

Although a description was mainly given of the case where the content is an information program for broadcasting in the above embodiment, the embodiments of the present disclosure are not limited thereto. For example, the content may be a program other than the information program, and may be a package content which is not for broadcasting. For example, the content may be a movie provided in the form of package content, and when a location in the content is specified, information on clothes that a performer wears in the movie may be acquired as content-related information, or information on a vehicle that appears in the movie may be acquired as content-related information for example. Furthermore, the content may be treated not as a program unit, but rather a series of programs that are broadcasted at a given channel may be treated as one content.

The content-related information may also be the information, as in the above-described example, which is retrieved on a network by using the information for specifying content and the information for specifying a location in the content as key information, or may be meta information distributed together with a program to be broadcasted for example.

The embodiments of the present disclosure may include, for example, an information processing apparatus (a terminal device or a server) as described above, a system, an information processing method executed by the information processing apparatus or the system, a program for functioning the information processing apparatus, and a storage medium storing the program.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

Additionally, the present technology may also be configured as below.

(1) An information processing apparatus including:

a first information acquiring section acquiring location specification information which indicates content being viewed by a user and a location in the content specified by the user;

a second information acquiring section acquiring, based on the location specification information, content-related information provided corresponding to the content for the location; and

an action support information generating section generating action support information for the user by using the content-related information.

(2) The information processing apparatus according to (1), wherein

the action support information generating section accumulates a characteristic of the content-related information as learned data.

(3) The information processing apparatus according to (2), further including:

a log acquiring section acquiring an activity log of the user on a network,

wherein the action support information generating section acquires, based on the learned data, log related information relating to a character string extracted from the activity log and generates, based on the log related information, action support information candidates for the user.

(4) The information processing apparatus according to (3), wherein

the action support information generating section accumulates, as the learned data, a characteristic of information which has been registered as the action support information among the candidates.

(5) The information processing apparatus according to (3) or (4), wherein

the activity log includes a message log transmitted or received by the user.

(6) The information processing apparatus according to any one of (3) to (5), wherein

the activity log includes contents of the content on the network in which the user has taken action.

(7) The information processing apparatus according to any one of (2) to (6),

wherein the first information acquiring section acquires, from an operation section acquiring operation of the user for specifying the location, information indicating an operation amount of the operation, and

wherein the action support information generating section reflects the operation amount at a time when the location specification information corresponding to the content-related information is acquired in the learned data as a level of interest of the user in the content-related information.

(8) The information processing apparatus according to any one of (1) to (7), wherein

the first information acquiring section acquires an image or a sound snapshot of the content as information indicating at least one of the content and the location.

(9) The information processing apparatus according to any one of (1) to (8), further including:

a log acquiring section acquiring an activity log of the user on a network,

wherein the first information acquiring section acquires, based on the activity log, information indicating at least one of the content and the location.

(10) The information processing apparatus according to any one of (1) to (9), wherein

the first information acquiring section acquires a time stamp as information indicating the location.

(11) The information processing apparatus according to any one of (1) to (10), wherein

the first information acquiring section acquires information of a seek point set for the content as information indicating the location.

(12) The information processing apparatus according to any one of (1) to (11),

wherein the content is a broadcast program, and

wherein the second information acquiring section acquires the content-related information after elapse of a predetermined time from an end of the broadcast program.

(13) The information processing apparatus according to (12),

wherein, when the content-related information is not acquired based on the

location specification information while or after the broadcast program is broadcast, the second information acquiring section generates temporary content-related information including at least information indicating the content, and

wherein the action support information generating section uses the temporary content-related information in place of the content-related information to generate the action support information until the content-related information is acquired.

(14) The information processing apparatus according to any one of (1) to (13), wherein

the action support information generating section generates the action support information including at least the information which indicates the content corresponding to the content-related information.

(15) The information processing apparatus according to any one of (1) to (14), further including:

a notice section outputting a notice to the user when the action support information is generated with use of the content-related information having a location attribute and location information of the user is close to the location.

(16) The information processing apparatus according to any one of (1) to (15), further including:

a notice section outputting a notice to the user when the action support information is generated with use of the content-related information having a deadline attribute and the deadline comes close.

(17) An information processing method including:

acquiring location specification information which indicates content being viewed by a user and a location in the content specified by the user;

acquiring, based on the location specification information, content-related information provided corresponding to the content for the location; and

generating action support information for the user by using the content-related information.

(18) A program for causing a computer to execute:

a function of acquiring location specification information which indicates content being viewed by a user and a location in the content specified by the user;

a function of acquiring, based on the location specification information, content-related information provided corresponding to the content for the location;

a function of generating action support information for the user by using the content-related information.

The present disclosure contains subject matter related to that disclosed in Japanese Priority Patent Application JP 2012-134695 filed in the Japan Patent Office on Jun. 14, 2012, the entire content of which is hereby incorporated by reference.

What is claimed is:

1. An information processing apparatus comprising:
a first information acquiring section acquiring location specification information which indicates content being viewed by a user and a location in the content specified by the user;
a second information acquiring section acquiring, based on the location specification information, content-related information provided corresponding to the content for the location; and
an action support information generating section generating action support information for the user by using the content-related information.

2. The information processing apparatus according to claim 1, wherein
the action support information generating section accumulates a characteristic of the content-related information as learned data.

3. The information processing apparatus according to claim 2, further comprising:
a log acquiring section acquiring an activity log of the user on a network,
wherein the action support information generating section acquires, based on the learned data, log related information relating to a character string extracted from the activity log and generates, based on the log related information, action support information candidates for the user.

4. The information processing apparatus according to claim 3, wherein
the action support information generating section accumulates, as the learned data, a characteristic of information which has been registered as the action support information among the candidates.

5. The information processing apparatus according to claim 3, wherein
the activity log includes a message log transmitted or received by the user.

6. The information processing apparatus according to claim 3, wherein
the activity log includes contents of the content on the net in which the user has taken action.

7. The information processing apparatus according to claim 2,
wherein the first information acquiring section acquires, from an operation section acquiring operation of the user for specifying the location, information indicating an operation amount of the operation, and
wherein the action support information generating section reflects the operation amount at a time when the location specification information corresponding to the content-related information is acquired in the learned data as a level of interest of the user in the content-related information.

8. The information processing apparatus according to claim 1, wherein
the first information acquiring section acquires an image or a sound snapshot of the content as information indicating at least one of the content and the location.

9. The information processing apparatus according to claim 1, further comprising:
a log acquiring section acquiring an activity log of the user on a network,
wherein the first information acquiring section acquires, based on the activity log, information indicating at least one of the content and the location.

10. The information processing apparatus according to claim 1, wherein
the first information acquiring section acquires a time stamp as information indicating the location.

11. The information processing apparatus according to claim 1, wherein
the first information acquiring section acquires information of a seek point set for the content as information indicating the location.

12. The information processing apparatus according to claim 1,
wherein the content is a broadcast program, and
wherein the second information acquiring section acquires the content-related information after elapse of a predetermined time from an end of the broadcast program.

13. The information processing apparatus according to claim 12,
wherein, when the content-related information is not acquired based on the location specification information while or after the broadcast program is broadcast, the second information acquiring section generates temporary content-related information including at least information indicating the content, and
wherein the action support information generating section uses temporary content-related information in place of the content-related information to generate the action support information until the content-related information is acquired.

14. The information processing apparatus according to claim 1, wherein
the action support information generating section generates the action support information including at least the information which indicates the content corresponding to the content-related information.

15. The information processing apparatus according to claim 1, further composing:
a notice section outputting a notice to the user when the action support information is generated with use of the content-related information haying a location attribute and location information of the user is close to the location.

16. The information processing apparatus according to claim 1, further comprising:
a notice section outputting a notice to the user when the action support information is generated with use of the content-related information having a deadline attribute and the deadline comes close.

17. An information processing method comprising:
acquiring location specification information which indicates content being viewed by a user and a location in the content specified by the user;
acquiring, based on the location specification information, content-related information provided corresponding to the content for the location; and
generating action support information for the user by using the content-related information.

18. A program for causing a computer to execute:
a function of acquiring location specification information which indicates content being viewed by a user and a location in the content specified by the user;
a function of acquiring, based on the location specification information, content-related information provided corresponding to the content for the location; and
a function of generating action support information for the user by using the content-related information.
